(19) United States
(12) Patent Application Publication
(10) Pub. No.: US 2010/0087569 A1
(43) Pub. Date: Apr. 8, 2010

(54) Hydrophobically Modified Cationic Copolymers

(76) Inventors: Stefan Friedrich, Garching (DE); Michael Eberwein, Emmerting (DE); Michael Schinabeck, Altenmarkt (DE); Gregor Herth, Trostberg (DE)

Correspondence Address: CURATOLO SIDOTI CO., LPA, 24500 CENTER RIDGE ROAD, SUITE 280, CLEVELAND, OH, 44145, US

(21) Appl. No.: 12/444,201

(22) PCT Filed: Oct. 19, 2007
(86) PCT No.: PCT/EP07/09071

§ 371 Date: Jul. 15, 2009

(30) Foreign Application Priority Data
Oct. 27, 2006 (DE) 10 2006 050 761.4

(51) Int. Cl. C04B 24/26; C08F 220/60; C08K 3/30; C08K 3/22

(52) U.S. Cl. 524/5; 526/307.3; 524/423; 524/433; 524/27

(57) ABSTRACT

The invention relates to a hydrophobically modified cationic copolymer which has at least three different structural units. Particularly in combination with anionic surfactants, a considerable improvement in the water retention in aqueous building material systems based on hydraulic binders, such as cement, can be achieved even in the case of high salt loads.

The present invention relates to a copolymer, a process for the preparation thereof, the use of the copolymer and a polymeric mixture and the use thereof.

In non-flowable building material systems, water-soluble non-ionic derivatives of polysaccharides, in particular cellulose derivatives and starch derivatives are widely used as rheology modifiers and water retention agents in order to retard or prevent the undesired evaporation of the water which is required for hydration and processability or the flowing away thereof into the substrate. In renders, adhesive mortars, filling compounds and joint fillers, but also in air-placed concretes for tunnel construction and in under water concretes, the water retention is controlled with such additives. As a result, such additives also have a decisive influence on the consistency (plasticity), smoothability, segregation, tack, adhesion (to the substrate and to the tool), stability and slip resistance and adhesive strength and compressive strength or shrinkage.

U.S. Pat. No. 6,187,887 and US-A-2004/024154 describe high molecular weight polymers which contain sulpho groups and have good water retention properties. Common to these polymers is that they are polyelectrolytes having a net anionic charge.

However, another important property of the additives in tile adhesives and renders is the thickening in the presence of increased salt concentrations. The polymers according to U.S. Pat. No. 6,187,887 show a drastic decrease in the thickening under such conditions, whereas additives according to US-A-2004/024154 are relatively stable in the presence of increased salt concentrations.

In the case of high-performance tile adhesives, for example, it is desirable to establish particularly short curing times in order to ensure the possibility of walking on the laid tiles at an early stage (about 5 hours) even at low temperatures (about 5° C.). This is achieved by extremely high doses of salts which act as accelerators, for example calcium formate. In the case of the use of such high salt loads (in particular divalent cations are critical), the polymers according to US-A-2004/024154 also lose a major part of their effectiveness.

In this respect, there is a certain necessity to formulate such high-performance tile adhesives with water-soluble, non-ionic derivatives of polysaccharides, in particular cellulose ethers, as water retention agents. However, this means a number of disadvantages for the user, which is caused by the fact that cellulose ethers have low thermal flocculation points, which in the end results in the water receptivity being drastically lower at temperatures above 30° C. Moreover, particularly in relatively high doses, cellulose ethers tend to have high tacks which disadvantageously have to be reduced by addition of further formulation components.

In addition to the anionic polymers described above, cationic copolymers can also be used:

U.S. Pat. No. 5,601,725 describes hydrophobically modified copolymers of diallyldimethylammonium chloride with dimethylaminoethyl acrylate or methacrylate, which have been quaternized with benzyl or cetyl chloride. The hydrophobic group is thus present in the same monomer building block as that which carries the cationic charge. This is also the case in the hydrophobically modified, water-soluble cationic copolymers described in U.S. Pat. No. 5,292,793. These are copolymers of acrylamide with a cationic monomer which is derived from dimethylaminoethyl acrylate or methacrylate, which was quaternized with an alkyl halide (C₈ to C₂₀). U.S. Pat. No. 5,071,934 describes hydrophobically modified copolymers which act as efficient thickeners for water and salt solutions. These are copolymers of acrylamide with a cationic monomer which is derived from dimethylaminopropyl methacrylamide which was quaternized with an alkyl halide (C₇ to C₂₃).

Common to all cationic polymers mentioned is that, owing to the hydrophobic alkyl group, these may have a thickening effect in water and in solutions having a low salt content but do not ensure sufficient thickening in building material systems having a high salt load. They also exhibit inadequate water retention properties in building material systems, both at low and at high salt load.

It is known that cationic polyelectrolytes interact intensively with oppositely charged surfactants. Thus, US-A-2004/209780 describes cationically modified polysaccharides and anionic surfactants as an additive to fracturing fluids. Here, use is made of the effect that polyelectrolytes interact strongly with oppositely charged surfactants via electrostatic attractive forces. In addition those hydrophobic groups of the surfactants which are bonded in this manner to the polymer have associative thickening effects. The interactions become even more complex if the polyelectrolyte too has hydrophobic groups bonded covalently to the main chain.

However, these hydrophobically modified cationic copolymers do not exhibit adequate thickening and have completely inadequate water retention properties, even in combination with anionic surfactants, in building material systems.

It was therefore the object of the present invention to provide copolymers as water retention agents and rheology modifiers for aqueous building material systems, which copolymers do not have said disadvantages even in the case of high salt loads.

This object is achieved by a copolymer comprising
i) 5 to 60 mol % of a structural unit a),
ii) 20 to 80 mol % of a structural unit b) and
iii) 0.01 to 3 mol % of a structural unit c),
   the structural unit a) being represented by the following general formula (I):

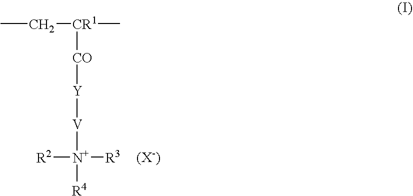

in which
R¹ is identical or different (i.e. R¹ may also vary within a copolymer) and is represented by hydrogen and/or a methyl radical,
R² and R³ are each identical or different and, independently of one another, are each represented by hydrogen, an aliphatic hydrocarbon radical having 1 to 20 C atoms (branched or straight-chain, preferably methyl or ethyl radical), a cycloaliphatic hydrocarbon radical having 5 to 8 C atoms (in particular cyclohexyl radical) and/or an aryl radical having 6 to 14 C atoms (in particular phenyl radical),
R⁴ is identical or different and is represented by a substituent identical to R² or R³, —(CH₂)ₓ—SO₃Mₖ,

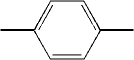

SO₃Mₖ and/or

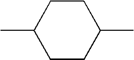

### SO₃Mₖ,

M is identical or different and is represented by a monovalent or divalent metal cation, ammonium cation (NH₄⁺) and/or quaternary ammonium cation (NR₁R₂R₃R₄)⁺,
k is identical or different and is represented by ½ and/or 1,
Y is identical or different and is represented by oxygen, —NH and/or —NR²,
V is identical or different and is represented by —(CH₂)ₓ—,

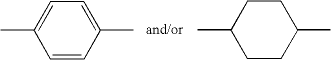

x is identical or different and is represented by an integer from 1 to 6 (preferably 1 or 2),
X is identical or different and is represented by a halogen atom (preferably Cl or Br), C₁- to C₄-alkylsulphate (preferably methylsulphate) and/or C₁- to C₄-alkanesulphonate (preferably methanesulphonate),
   the structural unit b) being represented by the following general formulae (IIa) and/or (IIb):

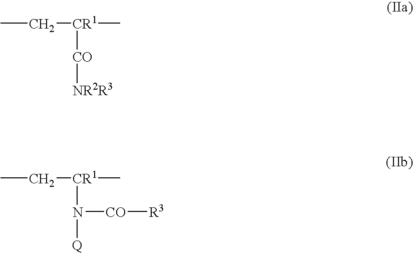

in which
Q is identical or different and is represented by hydrogen and/or —CHR²R⁵,
R¹, R² and R³ each have the abovementioned meanings, with the proviso that, where Q is not hydrogen, R² and R³ in the general formula (IIb) together may represent a —CH₂—(CH₂)_{y}— methylene group, so that the general formula (IIb) is present according to the following structure:

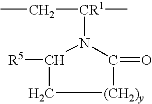

where
R⁵ is identical or different and is represented by a hydrogen atom, a C₁- to C₄-alkyl radical, a carboxyl group and/or a carboxylate group —COOMₖ, y being identical or different and being represented by an integer from 1 to 4 (preferably 1 or 2), and M and k each have the abovementioned meanings, the structural unit c) being represented by the general formula (III):

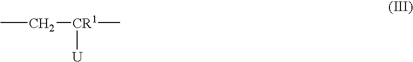

in which
U is identical or different and is represented by —COO(CₘH₂ₘO)ₙ—R⁶, and/or —(CH₂)ₚ—O(CₘH₂ₘO)ₙ—R⁶,
m is identical or different and is represented by an integer between 2 and 4 (preferably 1 or 2),
n is identical or different and is represented by an integer between 1 and 200 (preferably 1 to 20),
p is identical or different and is represented by an integer between 0 and 20 (preferably 1 to 5),
R⁶ is identical or different and is represented by

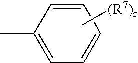

(in the case of z=3: preferably (R⁷)_{z} on the aromatic in the para- and ortho-positions),
R⁷ is identical or different and is represented by hydrogen, a C₁- to C₆-alkyl group (straight-chain or branched, preferably methyl or ethyl group) and/or an arylalkyl group having a C₁- to C₁₂-alkyl radical (straight-chain or branched, preferably methyl or ethyl radical) and C₆- to C₁₄-aryl radical (preferably styryl radical),
z is identical or different and is represented by an integer between 1 and 3 (preferably 3) (z indicates how many R⁷ are bonded to the phenyl radical) and
R¹ has the abovementioned meaning.

By means of these copolymers according to the invention, considerable improvements in the water retention in aqueous building material systems based on hydraulic binders, such as cement, lime, gypsum, anhydrite, etc., can also be achieved in the case of high salt loads. The rheology modification, the water retentivity, the tack and the processing profile can also be optimally adjusted for the respective application, depending on the composition of the copolymers.

The good water solubility required for the use of the copolymer according to the invention in aqueous building material applications is ensured in particular by the cationic structural unit a). The neutral structural unit b) is required mainly for the synthesis of the main chain and for achieving the suitable chain lengths, and associative thickening which is advantageous for the desired product properties being permitted by the hydrophobic structural units c).

The structural unit a) preferably arises from the polymerization of one or more of the monomer species [2-(acryloyloxy)ethyl]trimethylammonium chloride, [2-(acryloylamino)ethyl]trimethylammonium chloride, [2-(acryloyloxy)ethyl]trimethylammonium methosulphate, [2-(methacryloyloxy)ethyl]trimethylammonium chloride or methosulphate, [3-(acryloylamino)propyl]trimethylammonium chloride, [3-(methacryloylamino)propyl]trimethylammonium chloride, N-(3-sulphopropyl)-N-methylacryloyloxyethyl-N′,N-dimethylammonium betaine, N-(3-sulphopropyl)-N-methacrylamidopropyl-N,N-dimethylammonium betaine and/or 1-(3-sulphopropyl)-2-vinylpyridinium betaine.

It is in principle feasible to replace up to about 15 mol % of the structural units a) by further cationic structural units which are derived from N,N-dimethyldiallylammonium chloride and N,N-diethyldiallylammonium chloride.

As a rule, the structural unit b) arises from the polymerization of one or more of the monomer species acrylamide, methacrylamide, N-methylacrylamide, N,N-dimethylacrylamide, N-ethylacrylamide, N-cyclohexylacrylamide, N-benzylacrylamide, N-methylolacrylamide, N-tert-butylacrylamide, etc. Examples of monomers as a basis for the structure (IIb) are N-methyl-N-vinylformamide, N-methyl-N-vinylacetamide, N-Vinylpyrrolidone, N-vinylcaprolactam and/or N-vinylpyrrolidone-5-carboxylic acid.

In general, the structural unit c) arises from the polymerization of one or more of the monomer species tristyrylphenol polyethylene glycol-1100-methacrylate, tristyrylphenol polyethylene glycol-1100 acrylate, tristyrylphenol polyethylene glycol-1100-monovinyl ether, tristyrylphenol polyethylene glycol-1100 vinyloxybutyl ether and/or tristyrylphenol polyethylene glycol-block-polypropylene glycol allyl ether.

In a preferred embodiment of the invention, the copolymer contains 15 to 50 mol % of structural units a), 30 to 75 mol % of b) and 0.03 to 1 mol % of c).

In general, the copolymer described above also contains up to 5 mol %, preferably 0.05 to 3 mol %, of a structural unit d), which is represented by the general formula (IV)

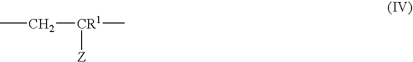

in which
Z is identical or different and is represented by —COO(CₘH₂ₘO)ₙ—R⁸ and/or
   —(CH₂)ₚ—O(CₘH₂ₘO)ₙ—R⁸,
R⁸ is identical or different and is represented by hydrogen and/or C₁- to C₄-alkyl (branched or straight-chain, preferably methyl or ethyl), and
R¹, m, n and p have the meanings mentioned in each case above.

As a rule, the structural unit d) arises from the polymerization of one or more of the following monomer species allylpolyethylene glycol-(350 to 2000), methylpolyethylene glycol-(350 to 3000) monovinyl ether, polyethylene glycol-(500 to 5000) vinyloxybutyl ether, polyethylene glycol-block-propylene glycol-(500 to 5000) vinyloxybutyl ether, methylpolyethylene glycol-block-propylene glycol allyl ether, methylpolyethylene glycol-750 methacrylate, polyethylene glycol-500 methacrylate, methylpolyethylene glycol-2000 monovinyl ether and/or methylpolyethylene glycol-block-propylene glycol allyl ether.

Copolymers according to the invention which contain the structural unit d) impart further improved creaminess to the building material, which is advantageous for the processor.

Frequently, the copolymer according to the invention contains up to 40 mol %, preferably 0.1 to 30 mol %, of a structural unit e) which is represented by the general formula (V):

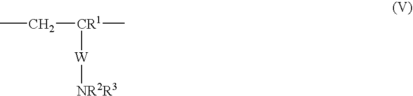

in which
W is identical or different and is represented by —CO—O—(CH₂)ₓ— and/or —CO—NR²—(CH₂)ₓ— and
R¹, R², R³ and x each have the abovementioned meanings.

Usually, the structural unit e) arises from the polymerization of one or more of the following monomer species [3-(methacryloylamino)propyl]dimethylamine, [3-(acryloylamino)propyl]dimethylamine, [2-(methacryloyloxy)ethyl]dimethylamine, [2-(acryloyloxy)ethyl]dimethylamine, [2-(methacryloyloxy)ethyl]diethylamine and/or [2-(acryloyloxy)ethyl]diethylamine.

By incorporating the structural unit e), the air pore stability of the copolymers obtained is improved.

In many cases, the copolymer according to the invention also contains up to 20 mol %, preferably 0.1 to 10 mol %, of a structural unit f) which is represented by the general formula (VI):

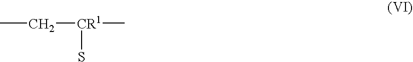

in which
S is identical or different and is represented by —COOMₖ and
M, k and R¹ each have the abovementioned meanings.

As a rule, the structural unit f) arises from the polymerization of one or more of the following monomer species: acrylic acid, sodium acrylate, methacrylic acid and/or sodium methacrylate.

Copolymers which contain the structural unit f) have advantages in building material systems in which particularly short mixing times are required.

The number of repeating structural units in the copolymer according to the invention is not limited and depends to a great extent on the respective field of use. However, it has proved to be advantageous to adjust the number of structural units so that the copolymers have a number average molecular weight of 50 000 to 20 000 000.

The copolymer according to the invention may acquire a slightly branched and/or slightly crosslinked structure by the incorporation of small amounts of crosslinking agents. Examples of such crosslinking components are triallylamine, triallylmethylammonium chloride, tetraallylammonium chloride, N,N′-methylenebisacrylamide, triethylene glycol bismethacrylate, triethylene glycol bisacrylate, polyethylene glycol(400) bismethacrylate and polyethylene glycol(400) bisacrylate. These compounds should be used only in amounts such that copolymers which are still water-soluble are obtained. In general, the concentration will seldom exceed 0.1 mol %, based on the sum of the structural units a) to f)—however, the person skilled in the art can readily determine the maximum usable amount of crosslinking component.

The copolymers according to the invention are prepared in a manner known per se by linkage of the monomers forming the structural units a) to f) (d) to f) optional in each case) by free radical polymerization. Since the products according to the invention are water-soluble copolymers, polymerization in the aqueous phase, polymerization in inverse emulsion or polymerization in inverse suspension is preferred. Expediently, the preparation is effected by gel polymerization in the aqueous phase.

In the case of the preferred gel polymerization, it is advantageous if polymerization is effected at low reaction temperatures and with a suitable initiator system. By the combination of two initiator systems (azo initiators and redox system), which are started first photochemically at low temperatures and then thermally owing to the exothermic nature of the polymerization, the conversion of ≧99% can be achieved. Other auxiliaries, such as molecular weight regulators, e.g. thioglycolic acid, mercaptoethanol, formic acid and sodium hypophosphite, can likewise be used. The gel polymerization is preferably effected at −5 to 50° C., the concentration of the aqueous solution preferably being adjusted to 25 to 70% by weight. For carrying out the polymerization, the monomers to be used according to the invention are expediently mixed in aqueous solution with buffers, molecular weight regulators and other polymerization auxiliaries. After adjustment of the polymerization pH, which is preferably between 4 and 9, flushing of the mixture with an inert gas, such as helium or nitrogen, and subsequently heating or cooling to the appropriate polymerization temperature are effected. If the unstirred gel polymerization procedure is employed, polymerization is effected in preferred layer thicknesses of from 2 to 20 cm, in particular 8 to 10 cm, under adiabatic reaction conditions. The polymerization is initiated by addition of the polymerization initiator and by irradiation with UV light at low temperatures (between −5 and 10° C.). After complete conversion of the monomers, the polymer is ground with the use of a release agent (e.g. Sitren® 595 from Goldschmidt GmbH) in order to accelerate the drying by means of larger surface area. By means of reaction and drying conditions which are as gentle as possible, secondary crosslinking reactions can be avoided so that polymers which have a low gel content are obtained.

The preferred amounts used of the copolymers according to the invention are between 0.005 and 5% by weight, based on the dry weight of the building material system and depending on the method of use.

The dried copolymers are used according to the invention in powder form for dry mortar applications (e.g. tile adhesive). The size distribution of the particles should be chosen as far as possible by adapting the milling parameters so that the mean particle diameter is less than 100 μm (determination according to DIN 66162) and the proportion of particles having a particle diameter greater than 200 μm is less than 2% by weight (determination according to DIN 66162). Preferred powders are those whose mean particle diameter is less than 60 μm and in which the proportion of the particles having a particle diameter greater than 120 μm is less than 2% by weight. Particularly preferred powders are those whose mean particle diameter is less than 50 μm and in which the proportion of particles having a particle diameter greater than 100 μm is less than 2% by weight.

The copolymer according to the invention is used as an admixture for aqueous building material systems which contain hydraulic binders, in particular cement, lime, gypsum or anhydrite.

The hydraulic binders are preferably present as a dry mortar composition, in particular as tile adhesive or gypsum plaster.

A further improvement in said properties can be achieved by using the copolymer according to the invention as a mixture together with an anionic surfactant.

The invention thus also provides a polymeric mixture containing
α) the copolymer according to the invention and
β) an anionic surfactant which is represented by the general formulae

J-K (VII)

or

T-B—K, (VIII)

J and T each representing the hydrophobic part of the surfactant, K being an anionic functional group, T representing a hydrophobic part of the surfactant and B being a spacer group,
J being represented by an aliphatic hydrocarbon radical having 8 to 30 C atoms (branched or straight-chain, preferably 8 to 12 C atoms), a cycloaliphatic hydrocarbon radical having 5 to 8 C atoms (in particular cyclohexyl) or an aryl radical having 6 to 14 C atoms (in particular phenyl),
K being represented by —SO₃Mₖ, —OSO₃Mₖ, —COOMₖ, or —OP(O)(OH)OMₖ,
M and k each having the abovementioned meaning,
T being represented by an aliphatic hydrocarbon radical having 8 to 30 C atoms (branched or straight-chain, preferably 8 to 12 C atoms), a cycloaliphatic hydrocarbon radical having 5 to 8 C atoms (in particular cyclohexyl), an aryl radical having 6 to 14 C atoms (in particular phenyl) or R⁶,
B being represented by —O(CₘH₂ₘO)ₙ— and
K, R⁶, m and n each having the abovementioned meanings.

The polymeric mixture preferably comprises 80 to 99% by weight of the copolymer according to the invention and 1 to 20% by weight of the anionic surfactant described above.

The anionic surfactant according to the general formula (VII) is usually present as alkanesulphonate, arylsulphonate, alpha-olefinsulphonate or alkylphosphonate or as a fatty acid salt, and the anionic surfactant of the general formula (VIII) generally as alkyl ether sulphate.

It is also possible to use mixtures of said compound classes of the anionic surfactants.

The polymeric mixture according to the invention has practically the same application profile as the copolymer according to the invention and is preferably used as an admixture for aqueous building material systems which contain hydraulic binders.

The copolymers and polymeric mixtures according to the invention may each also be used in combination with non-ionic polysaccharide derivatives, such as methylcellulose (MC), hydroxyethylcellulose (HEC), hydroxypropylcellulose (HPC), methylhydroxyethylcellulose (MHEC), methylhydroxypropylcellulose (MHPC) and welan gum and/or diutan gum.

The following examples are intended to explain the invention in more detail.

### Copolymer 1 (Gel Polymerization)

296 g of water were initially introduced into a 2 l three-necked flask having a stirrer and thermometer. 319 g (0.92 mol, 26.8 mol %) of [3-(acryloylamino)propyl]trimethylammonium chloride (60% strength by weight solution in water) (I), 355 g (2.5 mol, 73 mol %) of acrylamide (50% strength by weight solution in water) (II) and 19 g (0.0068 mol, 0.2 mol %) of tristyrylphenol polyethylene glycol-1100 methacrylate (60% strength solution in water) (III) were then added in succession. 50 ppm of formic acid were added as a molecular weight regulator. The solution was adjusted to pH 7 with 20% strength sodium hydroxide solution, rendered inert with nitrogen by flushing for 30 minutes and cooled to about 5° C. The solution was transferred to a plastic container having the dimensions (w·d·h) 15 cm·10 cm·20 cm, and 150 mg of 2,2′-azobis(2-amidinopropane) dihydrochloride, 1.0 g of 1% strength Rongalit C solution and 10 g of 0.1% strength tert-butyl hydroperoxide solution were then added in succession. The polymerization was started by irradiation with UV light (two Philips tubes; Cleo Performance 40 W). After about 2 h, the hard gel was removed from the plastic container and cut with scissors into approx. 5 cm·5 cm·5 cm gel cubes. Before the gel cubes were ground by means of a conventional mincer, they were coated with the release agent Sitren 595 (polydimethylsiloxane emulsion; from Goldschmidt). The release agent is a polydimethylsiloxane emulsion, which was diluted 1:20 with water.

The resulting gel granules of copolymer 1 were distributed uniformly on a drying grille and dried in a circulation drying oven at about 90-120° C. in vacuo to constant weight.

About 375 g of white, hard granules were obtained, which were converted into a pulverulent state with the aid of a centrifugal mill. The mean particle diameter of the polymer powder of copolymer 1 was 40 μm and the proportion of particles having a particle diameter greater than 100 μm was less than 1% by weight.

### Copolymer 2

In a manner corresponding to copolymer 1, copolymer 2 was prepared from 48 mol % of [3-(acryloylamino)propyl]trimethylammonium chloride (I), 51.4 mol % of acrylamide (II), 0.3 mol % of tristyrylphenol polyethylene glycol-1100 methacrylate (III) and 0.3 mol % of polyethylene glycol-(2000) vinyloxybutyl ether (IV). 80 ppm of formic acid were used as a molecular weight regulator.

### Copolymer 3

In a manner corresponding to copolymer 1, copolymer 3 was prepared from 38 mol % of [3-(methacryloylamino)propyl]trimethylammonium chloride (I), 61 mol % of acrylamide (II), 0.3 mol % of tristyrylphenol polyethylene glycol-1100 methacrylate (III) and 0.7 mol % of methyl polyethylene glycol-(3000) monovinyl ether (IV). 200 ppm of formic acid were used as a molecular weight regulator.

### Copolymer 4

In a manner corresponding to copolymer 1, copolymer 4 was prepared from 26 mol % of [2-(methacryloyloxy)ethyl]trimethylammonium chloride (I), 65 mol % of acrylamide (II), 0.2 mol % of tristyrylphenol polyethylene glycol-1100 methacrylate (III) and 8.8 mol % of [2-(methacryloyloxy)ethyl]diethylamine (V). 80 ppm of formic acid were added as a molecular weight regulator.

### Copolymer 5

In a manner corresponding to copolymer 1, copolymer 5 was prepared from 16 mol % of [3-(acryloylamino)propyl]trimethylammonium chloride (I), 56.8 mol % of acrylamide (II), 0.2 mol % of tristyrylphenol polyethylene glycol-1100 methacrylate (III) and 27 mol % of a [3-(acryloylamino)propyl]dimethylamine (V). 40 ppm of formic acid were used as a molecular weight regulator.

### Copolymer 6

In a manner corresponding to copolymer 1, copolymer 6 was prepared from 27 mol % of [3-(methacryloylamino)propyl]trimethylammonium chloride (I), 55.6 mol % of acrylamide (II), 0.2 mol % of tristyrylphenol polyethylene glycol-1100 methacrylate (III), 0.2 mol % of polyethylene glycol-block-propylene glycol-(1100) vinyloxybutyl ether (IV) and 17 mol % of [3-(methacryloylamino)propyl]dimethylamine (V). 40 ppm of formic acid were used as a molecular weight regulator.

### Copolymer 7

In a manner corresponding to copolymer 1, copolymer 7 was prepared from 45.4 mol % of [3-(acryloylamino)propyl]trimethylammonium chloride (I), 48 mol % of acrylamide (II), 0.3 mol % of tristyrylphenol polyethylene glycol-1100 methacrylate (III), 0.3 mol % of polyethylene glycol-block-propylene glycol-(3000) vinyloxybutyl ether (IV) and 6 mol % of acrylic acid (VI). 70 ppm of formic acid were added as a molecular weight regulator.

### Copolymer 8

In a manner corresponding to copolymer 1, copolymer 8 was prepared from 28 mol % of [2-(methacryloyloxy)ethyl]trimethylammonium chloride (I), 46.7 mol % of N,N-dimethylacrylamide (II), 0.3 mol % of tristyrylphenol polyethylene glycol-1100 methacrylate (III), 21 mol % of [3-(acryloylamino)propyl]dimethylamine (V) and 4 mol % of acrylic acid (VI). 30 ppm of formic acid were added as a molecular weight regulator.

### Copolymer 9

In a manner corresponding to copolymer 1, copolymer 9 was prepared from 25 mol % of [2-(methacryloyloxy)ethyl]trimethylammonium chloride (I), 57 mol % of acrylamide (II), 0.2 mol % of tristyrylphenol polyethylene glycol-1100 methacrylate (III), 0.2 mol % of polyethylene glycol-block-propylene glycol-(2000) vinyloxybutyl ether (IV), 12 mol % of [3-(acryloylamino)propyl]dimethylamine (V) and 5.6 mol % of acrylic acid (VI). 30 ppm of formic acid were added as a molecular weight regulator.

### Polymeric Mixture 1

Consisting of 95% by weight of copolymer 3 and 5% by weight of C₁₄/C₁₆-alpha-olefinsulphonate sodium salt (VII) (Hostapur OSB from SE Tylose GmbH & Co. KG).

### Polymeric Mixture 2

Consisting of 85% by weight of copolymer 9 and 15% by weight of sodium lauryl sulphate (VII) (commercial product from F.B. Silbermann GmbH & Co. KG).

### Comparative Polymer 1/Comparative Example 1

Comparative polymer 2 was prepared from 20 mol % of ([2-(methacryloyloxy)ethyl]dimethylcetylammonium bromide and 80 mol % of acrylamide according to U.S. Pat. No. 5,292,793.

### Comparative Polymer 2/Comparative Example 2

Comparative polymer 3 was prepared from 47.1 mol % of 2-acrylamido-2-methylpropanesulphonic acid, 49.1 mol % of acrylamide, 0.7 mol % of tristyrylphenol polyethylene glycol-1100 methacrylate and 3.1 mol % of 2-(methacrylamido)propyl]trimethylammonium chloride according to US-A-2004/024154.

### USE EXAMPLES

The assessment of the use of the copolymers and polymeric mixtures according to the invention was effected on the basis of test mixtures from the area of stable tile adhesive mortars and gypsum plasters.

Tile Adhesive Mortars:

For this purpose, the test was effected under conditions close to practice with the use of a dry mixture which was formulated ready for use and with which the copolymers according to the invention or the comparative polymers were mixed in solid form. After the dry mixing, a certain amount of water was added and thorough stirring was effected by means of a drill with a G3 mixer (duration 2.15 seconds). After a ripening time of 5 min, the tile adhesive mortar was subjected to a first visual inspection.

### Determination of the Slump

The slump was determined after the ripening time and was determined a second time 30 min after stirring (after brief manual stirring) according to DIN 18555, part 2.

### Determination of the Water Retention

The water retention was determined about 15 min after stirring according to DIN 18555, part 7.

### Determination of the Tack/Ease of Flow

The tack or ease of flow for the test mixture is determined by a qualified person skilled in the art.

### Determination of the Slip

The slip was determined about 3 min after stirring according to DIN EN 1308. The extent of the slip in mm is stated.

### Determination of the Development Time

The development time was determined during mixing with a Rilem mixer (speed I) by visual assessment by a person skilled in the art using a stopwatch.

### Determination of the Wetting of the Tiles

The tile adhesive formulation was applied to a concrete slab according to EN 1323 and, after 10 minutes, a tile (5×5 cm) was placed on top and was loaded with a weight of 2 kg for 30 seconds. After a further 60 minutes, the tile was removed and the percentage of the back of the tile to which adhesive was still adhering was determined.

The composition of the tile adhesive mortar is shown in table 1.

TABLE 1
Composition of the test mixture (in % by weight)

| | Amount |
|---|---|
| Component | (% by weight) |
| Cement¹⁾ | 37.50 |
| Quartz sand (0.05-0.4 mm) | 49.50 |
| Limestone flour²⁾ | 5.50 |
| Dispersion powder³⁾ | 3.50 |
| Cellulose fibre⁴⁾ | 0.50 |
| Calcium formate | 2.80 |
| Copolymers/comparative examples | 0.50 |
| Starch ether⁵⁾ | 0.15 |
| Polyacrylamide⁶⁾ | 0.05 |

¹⁾CEM II 42.5 R
²⁾Omyacarb 130 AL (From Omya, Oftingen, Switzerland)
³⁾Vinnapas RE 530 Z (Wacker Chemie AG, Munich)
⁴⁾Arbocel ZZC 500 (J. Rettenmaier & Söhne GmbH + Co., Rosenberg)
⁵⁾Eloset 5400 (from Elotex, Sempach, Switzerland)
⁶⁾Floset 130 U DP (from SNF Floerger, Andrézieux Cedex, France)

The tile adhesive mortar is similar to a C2FTE tile adhesive mortar (according to DIN EN 12004) formulated with 2.80% by weight of calcium formate as an accelerator. The test results obtained with the copolymers according to the invention, polymeric mixtures and the comparative examples are shown in table 2.

TABLE 2
Processing properties of an adhesive mortar for ceramic tiles which was modified with mixtures
according to the invention and corresponding mixtures according to comparative examples.

| | | | Water | | | | | |
|---|---|---|---|---|---|---|---|---|
| | Slump | Slump | retention | Stirring-in | Wetting | | | Air pore |
| Admixture | (cm) | 30 min (cm) | (%) | time (s) | (%) | Tack | Slip (mm) | stability |
| Copolymer 1 | 18.2 | 17.2 | 98.8 | 15 | 81 | moderate | 2 | moderate |
| Copolymer 2 | 17.2 | 16.8 | 98.7 | 19 | 82 | slight | 3 | good |
| Copolymer 3 | 17.6 | 17.3 | 98.4 | 17 | 82 | slight | 5 | good |
| Copolymer 4 | 18.2 | 17.7 | 98.8 | 16 | 80 | slight | 2 | very good |
| Copolymer 5 | 18.8 | 17.7 | 98.2 | 10 | 89 | slight | 4 | very good |
| Copolymer 6 | 18.0 | 17.8 | 98.7 | 15 | 85 | slight | 6 | very good |
| Copolymer 7 | 17.2 | 16.6 | 98.9 | 14 | 90 | very slight | 2 | good |
| Copolymer 8 | 17.0 | 16.5 | 98.5 | 13 | 80 | very slight | 2 | very good |
| Copolymer 9 | 17.5 | 16.8 | 98.5 | 13 | 80 | very slight | 2 | very good |
| Polymeric mixture 1 | 17.9 | 17.8 | 98.9 | 14 | 86 | very slight | 0 | very good |
| Polymeric mixture 2 | 17.6 | 17.7 | 99.0 | 11 | 88 | very slight | 0 | very good |
| Comparative example 1 | 19.4 | 18.4 | 96.0 | 8 | 78 | moderate | >20 | poor |
| Comparative example 2 | 17.5 | 16.9 | 97.2 | 10 | 80 | moderate | 2 | very good |
| Cellulose ether MHPC 30000¹⁾ | 16.2 | 16.2 | 98.6 | 6 | 70 | very high | 8 | good |

¹⁾Mecellose PMC 30 U(S) from Samsung Fine Chemicals. Seoul, South Korea
Amount of water: 330 g
Adhesive mortar: 1000 g

The test results in table 2 show that the copolymers according to the invention have substantially better water retention values, lower tacks and substantially reduced viscosity on processing in the tile adhesive mortar than those according to comparative examples 1 and 2. The latter show considerable fall-off in the water retention at the high concentration of soluble calcium ions. The copolymers according to the invention, on the other hand, show particularly good water retention even at the high calcium content. The cellulose ether tested as a comparison imparts good water retention to the tile adhesive mortar at high calcium loads but does so in conjunction with an undesirably high tack which is disadvantageous for the processor.

The wetting of the tiles with the copolymers according to the invention tends to be better than with comparative polymers 1 and 2. The differences between the copolymers according to the invention with regard to the ease of flow and tack during processing of the tile adhesive mortar are marked. Especially copolymers 7, 8 and 9 show a distinctively low tack and an associated ease of flow during processing of the tile adhesive mortar. The pleasant and easy processability leads to a substantial reduction in the application of force during distribution of the tile adhesive mortar and to a simplification of the individual operations. The species according to comparative examples 1 and 2 show a substantially lower tack compared with the cellulose ether and improved ease of flow—but are inferior to the copolymers according to the invention.

In the assessment of the slip according to DIN EN 1308, all copolymers according to the invention and comparative polymer 2 are at the similar high level. The best stability, however, is shown by the polymeric mixtures with which slip can be completely prevented. The tile adhesive mortars comprising polymeric mixture likewise show particularly good ease of flow, low tack and excellent water retentivity.

All copolymers according to the invention show a high level with regard to air pore stability. Copolymers 4, 5, 6, 8 and 9, each of which contain the structural unit e) are distinguished by particularly good air pore stability.

Gypsum Plaster for Manual Application

For this purpose, the test was effected under conditions close to practice with the use of a dry mixture which was formulated ready for use and of which the copolymers according to the invention or the comparative products were mixed in solid form. After the dry homogenization, the test mixture was added to a defined amount of water in the course of 15 seconds, carefully stirred with a trowel and then further stirred thoroughly with a Rilem mixer (speed I) (duration 60 seconds). Thereafter, the mixture was allowed to ripen for 3 minutes and was stirred again under the above conditions for 15 seconds.

### Determination of the Development Time

The development time on mixing with a Rilem mixer (speed I) was determined subjectively by a visual assessment by a person skilled in the art using a stopwatch.

### Determination of the Water Retention

The water retention was determined after the ripening time according to DIN 18555, part 7.

### Determination of the Air Pore Stability

The air pore stability was determined qualitatively by visual assessment.

### Determination of the Tack/Ease of Flow

The tack or ease of flow of the test mixture was determined by a qualified person skilled in the art.

### Determination of the Stability

The stability of a 20 mm thick render layer freshly applied after the ripening time was determined by a qualified person skilled in the art.

### Determination of the Nodule Load

The nodule load was determined after the ripening time by visual and manual consideration by a qualified person skilled in the art.

The composition of the gypsum plaster is shown in table 3.

TABLE 3
Composition of the test mixture (in % by weight)

| | Amount |
|---|---|
| Component | (% by weight) |
| Calcium sulphate beta-hemihydrate | 45.0 |
| Slaked lime | 5.20 |
| Limestone flour (<0.1 mm) | 1.1 |
| Limestone sand (0.1-1 mm) | 47.2 |
| Perlite (0-1 mm) | 1.1 |
| Copolymers/comparative examples | 0.3 |
| Air pore former¹⁾ | 0.03 |
| Tartaric acid (retardant) | 0.07 |

¹⁾Genapol PF 80 p (Clariant GmbH, Frankfurt/Main)

TABLE 4
Processing properties of a gypsum plaster for manual application which was modified with
mixtures according to the invention and corresponding comparative mixtures.

| | | Water retention | Stirring-in time | | | Air pore |
|---|---|---|---|---|---|---|
| Admixture | Nodule count | (%) | (s) | Tack | Stability | stability |
| Copolymer 1 | low | 98.3 | 20 | moderate | high | good |
| Copolymer 2 | low | 98.2 | 24 | slight | high-moderate | good |
| Copolymer 3 | low | 97.4 | 21 | very slight | moderate | good |
| Copolymer 4 | low | 98.3 | 21 | slight | high | very good |
| Copolymer 5 | low | 97.6 | 15 | slight | high-moderate | very good |
| Copolymer 6 | low | 98.2 | 20 | slight | moderate | very good |
| Copolymer 7 | very low | 98.3 | 17 | very slight | high | good |
| Copolymer 8 | low | 98.0 | 18 | very slight | high | very good |
| Copolymer 9 | very low | 98.0 | 18 | very slight | high | very good |
| Polymeric mixture 1 | very low | 98.4 | 19 | very slight | very high | very good |
| Polymeric mixture 2 | very low | 98.6 | 16 | very slight | very high | very good |
| Comparative example 1 | moderate | 96.1 | 12 | moderate | slight | moderate |
| Comparative example 2 | low | 97.7 | 13 | moderate- | high-moderate | very good |
| | | | | slight | | |

Amount of water: 540 g
Dry mortar: 1.000 g

The test results in table 4 show that the copolymers according to the invention achieve a substantial improvement compared with the species according to comparative examples 1 and 2, especially in tack as a criterion of assessment and the ease of flow associated therewith. Furthermore, the copolymers according to the invention result in good stability. It is possible to apply extremely thick render layers and to process them with easy flow without the render mixture slumping from the walls. This advantage is distinctive especially with the polymeric mixtures 1 and 2. The water retention properties of the copolymers according to the invention are also superior to those of the species according to comparative examples 1 and 2. The pleasant and easy processing leads to a substantial reduction in the application of force during flowing and distribution of a fresh gypsum plaster and to simplification of the individual operations. All copolymers consistently show a high level with regard to air pore stability. Once again the copolymers 4, 5, 6, 8 and 9, which permit particularly good air pore stability and consequently improved distributability of the render mixture are particularly distinguished among them.

1. Copolymer comprising,
i) 5 to 60 mol % of a structural unit a),
ii) 20 to 80 mol % of a structural unit b) and
iii) 0.01 to 3 mol % of a structural unit c),
the structural unit a) being represented by the following general formula (I): 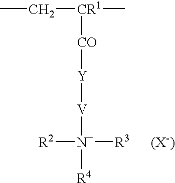
in which
R¹ is identical or different and is represented by hydrogen and/or a methyl radical,
R² and R³ are each identical or different and, independently of one another, are each represented by hydrogen, an aliphatic hydrocarbon radical having 1 to 20 C atoms, a cycloaliphatic hydrocarbon radical having 5 to 8 C atoms and/or an aryl radical having 6 to 14 C atoms,
R⁴ is identical or different and is represented by a substituent identical to R² or R³, —(CH₂)ₓ—SO₃Mₖ, 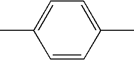
SO₃Mₖ and/or 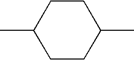
SO₃Mₖ,
M is identical or different and is represented by a monovalent or divalent metal cation, ammonium cation and/or quaternary ammonium cation (NR₁R₂R₃R₄)⁺,
k is identical or different and is represented by ½ and/or 1,
Y is identical or different and is represented by oxygen, —NH and/or —NR²,
V is identical or different and is represented by —(CH₂)ₓ—, 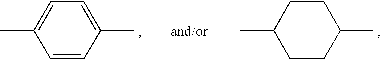
x is identical or different and is represented by an integer from 1 to 6,
X is identical or different and is represented by a halogen atom, C₁- to C₄-alkylsulphate and/or C₁- to C₄-alkanesulphonate,
the structural unit b) being represented by the following general formulae (IIa) and/or (IIb): 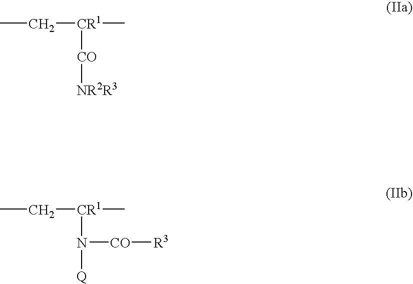
in which
Q is identical or different and is represented by hydrogen and/or —CHR²R⁵,
R¹, R² and R³ each have the abovementioned meanings, with the proviso that, where Q is not hydrogen, R² and R³ in the general formula (IIb) together may represent a —CH₂—(CH₂)_{y}— methylene group, so that the general formula (IIb) is present according to the following structure: 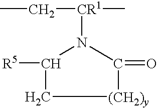
where
R⁵ is identical or different and is represented by a hydrogen atom, a C₁- to C₄-alkyl radical, a carboxyl group and/or a carboxylate group —COOMₖ, y being identical or different and being represented by an integer from 1 to 4, and M and k each have the abovementioned meanings,
the structural unit c) being represented by the general formula (III): 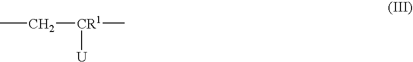
in which
U is identical or different and is represented by —COO(CₘH₂ₘO)ₙ—R⁶, and/or —(CH₂)ₚ—O(CₘH₂ₘO)ₙ—R⁶,
m is identical or different and is represented by an integer between 2 and 4,
n is identical or different and is represented by an integer between 1 and 200,
p is identical or different and is represented by an integer between 0 and 20,
R⁶ is identical or different and is represented by 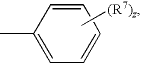
R⁷ is identical or different and is represented by hydrogen, a C₁- to C₅-alkyl group and/or an arylalkyl group having a C₁- to C₁₂-alkyl radical and C₆- to C₁₄-aryl radical,
z is identical or different and is represented by an integer between 1 and 3 and
R¹ has the abovementioned meaning.

2. Copolymer according to claim 1, characterized in that the structural unit a) arises from the polymerization of one or more of the monomer species [2-(acryloyloxy)ethyl]trimethylammonium chloride, [2-(acryloylamino)ethyl]trimethylammonium chloride, [2-(acryloyloxy)ethyl]trimethylammonium methosulphate, [2-(methacryloyloxy)ethyl]trimethylammonium chloride or methosulphate, [3-(acryloylamino)propyl]trimethylammonium chloride, [3-(methacryloylamino)propyl]trimethylammonium chloride, N-(3-sulphopropyl)-N-methylacryloyloxyethyl-N′,N-dimethylammonium betaine, N-(3-sulphopropyl)-N-methacrylamidopropyl-N,N-dimethylammonium betaine and/or 1-(3-sulphopropyl)-2-vinylpyridinium betaine.

3. Copolymer according to claim 1, characterized in that the structural unit b) arises from the polymerization of one or more of the monomer species acrylamide, methacrylamide, N-methylacrylamide, N,N-dimethylacrylamide, N-ethylacrylamide, N-cyclohexylacrylamide, N-benzylacrylamide, N-methylolacrylamide, N-tert-butylacrylamide, N-methyl-N-vinylformamide, N-methyl-N-vinylacetamide, N-Vinylpyrrolidone, N-vinylcaprolactam and/or N-vinylpyrrolidone-5-carboxylic acid.

4. Copolymer according to claim 1, characterized in that the structural unit c) arises from the polymerization of one or more of the monomer species tristyrylphenol polyethylene glycol-1100-methacrylate, tristyrylphenol polyethylene glycol-1100-acrylate, tristyrylphenol polyethylene glycol-1100-monovinyl ether, tristyrylphenol polyethylene glycol-1100 vinyloxybutyl ether and/or tristyrylphenol polyethylene glycol-block-propylene glycol allyl ether.

5. Copolymer according to claim 1, characterized in that the structural units a) are present in an amount of 15 to 50 mol %, b) in an amount of 30 to 75 mol % and c) in an amount of 0.03 to 1 mol %.

6. Copolymer according to claim 1, containing up to 5 mol %, optionally 0.05 to 3 mol %, of a structural unit d) which is represented by the general formula (IV): 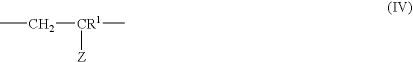
in which
Z is identical or different and is represented by —COO(CₘH₂ₘO)ₙ—R⁸ and/or —(CH₂)ₚ—O(CₘH₂ₘO)ₙ—R⁸,
R⁸ is identical or different and is represented by H and/or C₁- to C₄-alkyl and
R¹, m, n and p have the meanings mentioned in each case above.

7. Copolymer according to claim 6, characterized in that the structural unit d) arises from the polymerization of one or more of the following monomer species allylpolyethylene glycol-(350 to 2000), methylpolyethylene glycol-(350 to 3000) monovinyl ether, polyethylene glycol-(500 to 5000) vinyloxybutyl ether, polyethylene glycol-block-propylene glycol-(500 to 5000) vinyloxybutyl ether, methylpolyethylene glycol-block-propylene glycol allyl ether, methylpolyethylene glycol-750 methacrylate, polyethylene glycol-500 methacrylate, methylpolyethylene glycol-2000 monovinyl ether and/or methylpolyethylene glycol-block-propylene glycol allyl ether.

8. Copolymer according to claim 1 containing up to 40 mol %, optionally from 0.1 to 30 mol %, of a structural unit e) which is represented by the general formula (V): 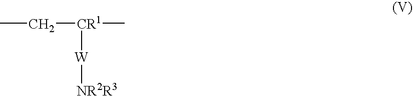
in which
W is identical or different and is represented by —CO—O—(CH₂)ₓ— and/or —CO—NR²—(CH₂)ₓ— and
R¹, R², R³ and x each have the abovementioned meanings.

9. Copolymer according to claim 8, characterized in that the structural unit e) arises from the polymerization of one or more of the following monomer species [3-(methacryloylamino)propyl]dimethylamine, [3-(acryloylamino)propyl]dimethylamine, [2-(methacryloyloxy)ethyl]dimethylamine, [2-(acryloyloxy)ethyl]dimethylamine, [2-(methacryloyloxy)ethyl]diethylamine and/or [2-(acryloyloxy)ethyl]diethylamine.

10. Copolymer according to claim 1, containing up to 20 mol %, optionally 0.1 to 10 mol %, of a structural unit f) which is represented by the general formula (VI): 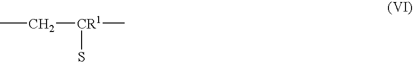
in which
S is identical or different and is represented by —COOMₖ and
M, k and R¹ each have the abovementioned meanings.

11. Copolymer according to claim 10, characterized in that the structural unit f) arises from the polymerization of one or more of the following monomer species acrylic acid, sodium acrylate, methacrylic acid and/or sodium methacrylate.

12. Copolymer according to claim 1, having a number average molecular weight of 50,000 to 20,000,000.

13. Copolymer according to claim 1, which has branched and/or crosslinked regions.

14. Process for the preparation of a copolymer according to claim 1 by free radical polymerization in the aqueous phase, by free radical polymerization in inverse emulsion or by free radical polymerization in inverse suspension.

15. Process according to claim 14, characterized in that the free radical polymerization is effected as a gel polymerization in the aqueous phase.

16. Process according to claim 14, characterized in that the free radical polymerization is effected in the presence of a crosslinking agent.

17. Process for using the copolymer according to claim 1 as an admixture for aqueous building material systems which contain hydraulic binders, cement, lime, gypsum or anhydrite, comprising mixing the copolymer with the hydraulic binders, cement, lime, gypsum or anhydrite.

18. Process according to claim 17, characterized in that the hydraulic binder is present as a dry mortar composition, tile adhesive or gypsum plaster.

19. Process according to claim 17, which is effected in combination with non-ionic polysaccharide derivatives.

20. Polymeric mixture containing
α) polymer according to any of claim 1 and
β) an anionic surfactant which is represented by the general formulae
J-K (VII)
or
T-B—K, (VIII)
J and T each representing the hydrophobic part of the surfactant, K being an anionic functional group, T representing a hydrophobic part of the surfactant and B being a spacer group,
J being represented by an aliphatic hydrocarbon radical having 8 to 30 C atoms, a cycloaliphatic hydrocarbon radical having 5 to 8 C atoms or an aryl radical having 6 to 14 C atoms,
K being represented by —SO₃Mₖ, —OSO₃Mₖ, —COOMₖ, or —OP(O)(OH)OMₖ,
M and k each having the abovementioned meaning,
T being represented by an aliphatic hydrocarbon radical having 8 to 30 C atoms, a cycloaliphatic hydrocarbon radical having 5 to 8 C atoms, an aryl radical having 6 to 14 C atoms or R⁶,
B being represented by —O(CₘH₂ₘO)ₙ— and
K, R⁶, m and n each having the abovementioned meanings.

21. Polymeric mixture according to claim 20, comprising 80 to 99% by weight of the copolymer and 1 to 20% by weight of the anionic surfactant.

22. Polymeric mixture according to claim 20, characterized in that the anionic surfactant according to the general formula (VII) is present as alkanesulphonate, arylsulphonate, alpha-olefinsulphonate or alklyphosphate or as a fatty acid salt, and the anionic surfactant of the general formula (VIII) as alkyl ether sulphate.

23. Process for using the polymeric mixture according to claim 20 as an admixture for aqueous building material systems which contain hydraulic binders, comprising mixing the copolymer with the hydraulic binders.

24. Process according to claim 23, which is effected in combination with non-ionic polysaccharide derivatives.
